(19) United States
(12) Patent Application Publication
(10) Pub. No.: US 2008/0215345 A1
(43) Pub. Date: Sep. 4, 2008

(54) Materials management system and method

(75) Inventors: Stephen Allen Hollingsworth, San Marcos, CA (US); Jeffrey Anton Kacirek, Oceanside, CA (US); Richard Franklin McCrea, Oceanside, CA (US); Isaac Baden Powell, Vista, CA (US); Karlton Devon Prillerman, Winchester, CA (US); Charles Scott Hewison, San Marcos, CA (US); Christopher Mark Kraus, Encinitas, CA (US)

Correspondence Address: MORRISON & FOERSTER LLP, 12531 HIGH BLUFF DRIVE, SUITE 100, SAN DIEGO, CA, 92130-2040, US

(73) Assignee: 3E COMPANY ENVIRONMENTAL ECOLOGICAL & ENGINEERING, Carlsbad, CA (US)

(21) Appl. No.: 11/507,967

(22) Filed: Aug. 21, 2006

Related U.S. Application Data
(63) Continuation-in-part of application No. 11/388,376, filed on Mar. 23, 2006.

(51) Int. Cl. G06Q 10/00; G06F 17/30

(52) U.S. Cl. 705/1; 707/104.1; 707/E17.009

(57) ABSTRACT

A materials management system and method configured to handle materials events is provided. The materials management system can be configured to receive event information, comprising information pertaining to a hazardous materials event, to store data pertaining to a plurality of hazardous materials, to retrieve stored data based on the event information and to generate a materials event response based on the retrieved information. According to one embodiment, the materials management system can include an automated telephonic interface for accepting caller input and facilitating system responses.

### RELATED APPLICATION INFORMATION

This application is a continuation-in-part of U.S. patent application Ser. No. 11/388,376, filed on Mar. 23, 2006, the disclosures of which are herein incorporated by reference in their entirety.

### FIELD OF THE INVENTION

The present invention relates generally to materials handling, and more particularly to a system and method for managing one or more events associated with hazardous materials.

### BACKGROUND OF THE INVENTION

It has been reported that there are as many as 800,000 shipments of hazardous material daily. Some 40,000 businesses are reportedly involved in transporting these materials. Additionally, manufacturing plants, retail outlets, factories, laboratories, homes and other sites store and use various forms of hazardous materials from fertilizers to paints, to pesticides, to explosives. According to the transportation department, there are more than 10,000 incidents annually involving materials such as poisonous gas, flammable solids and combustible liquids. Many of these result in injuries and even death.

The United States government started regulating certain chemicals (explosives, oxidizers) as early as the 19^{th} Century. In 1966 congress established the Department of Transportation (DOT), which is responsible for hazardous materials transportation. In 1974 congress passed The Hazardous Materials Transportation Act, giving the secretary of transportation the authority to identify and regulate all modes of hazardous materials transportation. In addition to regulations governing the transport of materials, there are rules and policies governing the storage, handling, use and cleanup of various forms of hazardous materials.

For example, federal, state and local rules can dictate how certain materials are stored, how and by whom they can be used, how they are cleaned should a spill occur and how they are transported and how they are disposed. As a result, numerous entities from auto repair facilities, to hardware stores, to factories and plants, and so on, are required to be in compliance with these rules and regulations, and may also have internal requirements as well. Additionally, record keeping and reporting requirements force these entities to follow best practices in dealing with such materials. The regulations are numerous and in many cases have become so stringent and inclusive that training, knowledge and expertise are required for persons to handle or ship hazardous materials safely and within the law.

Numerous companies have paid fines and other penalties for breaching various of the material handling regulations. For example, one large home improvement center was alleged to have improperly tendered a parcel containing a portable generator that contained gasoline to a shipping company for air transportation. Ground handling employees at the third-party shipper's sorting facility discovered the shipment leaking. Companies have been known to offer hazardous materials for transportation when they were not properly packaged, labeled, marked, classified, described, documented, or otherwise not in a condition for shipment as required by regulations. The government has also alleged numerous cases where companies have failed to ensure employees are trained to properly package and handle hazardous materials, and did not make available at all times the required emergency response information.

### BRIEF SUMMARY OF THE INVENTION

According to one embodiment of the invention, a materials management system, is provided that is configured using one or more modules. In one embodiment, the modules can include: an event module, a data storage module and a response generation module. These and other modules of the invention can be implemented using hardware, software, firmware, or a combination thereof. Although the modules are described in terms of somewhat discrete functions that may be performed, this description is not intended to imply that physically or logically separate modules need to be provided to perform various of the described functions. Indeed, as would be apparent to one of ordinary skill in the art after reading this description, functions described as associated with the various modules can be assigned to dedicated hardware, software or firmware, or one or more functions can share common hardware, software or firmware.

The event module can be configured to receive event information, the event information comprising information pertaining to a hazardous materials event. A few examples of a hazardous materials event can include a hazardous material spill, and the materials event response comprises preparing and providing a hazardous material label to the service site. The event can be generated externally such as, for example, at a service site or other service facility. Alternatively, the event can be internally generated by the occurrence of events such as, for example, at periodic intervals.

As one example, the hazardous materials event may be the scheduled transportation of a hazardous material from one site to another, in which case an appropriate materials event response can comprise preparing and providing hazardous material transportation instructions to the transporter. As another example, the hazardous materials event may be a reporting requirement, and an appropriate materials event response can comprise preparing and providing a hazardous material report.

A data storage module can also be provided to store data pertaining to the plurality of hazardous materials that may be addressed by the materials management system. Additionally, a response generation module can be included to retrieve data from the data storage module based on the event information and further configured to generate a materials event response based on the retrieved information. The response generation module can further include modules such as, for example, a label generation module, a reporting module, an instructional module, a record keeping module, a statistical analysis module, and a scheduling module.

A communication module can also be provided to communicate with various components of the system. For example, a communication module can be provided to communicate with a service site or other facility, a remote access terminal or terminals, external data sources and remediation services or other systems and entities.

The materials management system can also include an event handling module, located at a service site and configured to receive user input pertaining to a hazardous materials event and to send event information regarding the hazardous materials event to the response generation module. The event handling module can further include a user interface device configured to accept the user input and to display event information to a user. Examples of such a device can include a handheld user interface, a kiosk, or other user terminal device. The materials management system can also include a remote access module, configured to provide a user with remote access to the materials management system.

The hazardous materials event can include at least one of a hazardous material spill, transportation of a hazardous material, disposal of a hazardous material, a reporting requirement for a hazardous material, and a use of a hazardous material. Additionally, the response can include at least one of providing material handling instructions to the service site, providing a hazardous waste label to the service site, scheduling remediation activities, generating a report, logging information, and performing statistical analysis.

In another embodiment, a method of responding to a hazardous materials event can be provided. The method can include the steps of receiving a hazardous material event from a service site; determining a hazardous material involved in the event; retrieving information relating to the hazardous material; generating a response to the hazardous material event, the response incorporating the retrieved information; and providing the response to the service site. The event can be received via at least one of telephone, facsimile, conventional mail or electronic message and can comprises at least one of a hazardous material spill, transportation of a hazardous material, disposal of a hazardous material, and use of a hazardous material. The response can include responses such as providing material handling instructions to the service site, providing a hazardous waste label to the service site, scheduling remediation activities, generating a report, logging information, and performing statistical analysis.

In yet another embodiment, a materials management system can include means for receiving event information from a service site, the event information comprising information pertaining to a hazardous materials event; means for storing data pertaining to a plurality of hazardous materials; and means, communicatively coupled to the communication module and the data storage module, for retrieving data from the data storage module based on the event information and for generating a materials handling response based on the retrieved information.

In still another embodiment, a computer program product comprising a computer readable medium having computer program code stored thereon is provided for managing materials events. The program code can include first computer program code configured to cause a processor to receive event information, the event information comprising information pertaining to a hazardous materials event; second computer program code configured to cause a processor to store data pertaining to a plurality of hazardous materials on a data storage module; and third computer program code configured to cause a processor to retrieve data from the data storage module based on the event information and further configured to generate a materials event response based on the retrieved information. Additionally, the third computer program code is further configured to cause a processor to generate a label, report or instructions, create a record, conduct statistical analysis module, and schedule a remediation activity.

The program code can further include computer program code configured to cause a processor to communicate with at least one of a service site, a remote access terminal, external data sources and remediation services. Additionally, in one embodiment the program code can include computer program code configured to cause a processor to receive user input pertaining to a hazardous materials event and to send event information regarding the hazardous materials event to the response generation module.

Further features and advantages of the present invention, as well as the structure and operation of various embodiments of the present invention, are described in detail below with reference to the accompanying drawings.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

FIG. 1 is a block diagram illustrating an example overview of a materials management system in accordance with one embodiment of the invention.

FIG. 2 is a diagram illustrating an example process for responding to an example event in accordance with one embodiment of the invention.

FIG. 3 is a diagram illustrating an example implementation of an overall materials management system in accordance with one embodiment of the invention.

FIG. 4 is an operational flow diagram illustrating an example process for creating a label with at least some level of human intervention in accordance of one embodiment of the invention.

FIG. 5 is an operational flow diagram illustrating an example process for creating a label in response to an event in accordance with one embodiment of the invention.

FIG. 6 is a diagram illustrating an example process for transporting hazardous materials from a location in accordance with one embodiment of the invention.

FIG. 7 is a diagram illustrating an example implementation of an automated telephone interface that can be used with a response-system in accordance with one embodiment of the invention.

FIG. 8 is a diagram illustrating an example label that can be generated in response to an event in accordance with one embodiment of the invention.

FIG. 9 is a diagram illustrating an example computing system in which various facets of the present invention can be implemented.

### DESCRIPTION OF THE PREFERRED EMBODIMENTS

The present invention is directed toward a system and method for providing a management system for materials handling. In one embodiment, the present invention provides a system and method for handling hazardous materials of various forms and at various locations. In another embodiment, the present invention provides a system and method for end-to-end materials management, providing for management at various stages including storage, cleanup, transportation, disposal, recordkeeping and reporting. As used herein, the term hazardous material can include any material, whether solid, liquid or gaseous, that might cause harm, is believed to cause harm, or might be suspected to cause harm, to the environment or to humans or other living organisms, regardless of how slight such harm may be, and regardless of the extent to which a causal link between a harm and the material has been established. Hazardous materials can include, for example, materials that may be flammable or explosive; materials that may be irritating or damaging to the skin, lungs or other parts of the body; materials that may be harmful or damaging to the environment; radioactive materials; carcinogens; and materials that may be considered asphyxiants, and allergens.

Before describing the invention in detail, it is useful to describe a few example environments with which the invention can be implemented. One such example is that of a retail outlet that stores various forms of hazardous material for resale to other businesses or to the public. Another example is a warehouse or other like facility used to store hazardous materials either as part of the distribution chain, or as a staging facility or for some other purpose. In these example environments, workers at the facilities may be tasked with handling the materials at various stages. For example, workers may be asked to shelve products for retail sale, assist customers with purchases of products, inventory on-hand products, fill product orders, transfer products from one shipment vessel to another, and other like activities. While these workers handle the materials on a regular basis, they may not always have the training or other specialized knowledge needed to safely handle the materials in accordance with regulations, especially, for example, in the event of a spill or other non-routine event. Another example environment is that of a materials production facility where one or more hazardous materials are manufactured either for internal use or for sale. Yet another example environment is that of a factory or business that uses hazardous materials in the conduct of its business. For example, an automobile repair facility may use petroleum products such as gasoline, diesel fuel and oil; antifreeze; asbestos; paint; aerosols, and other chemicals and materials.

From time-to-time, the present invention is described herein in terms of these example environments. Description in terms of these environments is provided to allow the various features and embodiments of the invention to be portrayed in the context of an exemplary application. After reading this description, it will become apparent to one of ordinary skill in the art how the invention can be implemented in different and alternative environments, and how the invention can be implemented for non-hazardous as well as hazardous materials.

The present invention is directed toward a system and method for materials management in a variety of different environments, applications, and settings. In an exemplary embodiment, the invention is directed toward systems and methods for providing information, management, and record keeping for the management of materials, including hazardous materials, in a variety of settings. The system can be implemented to provide instructions, information, remediation facilitation, reports, scheduling, data feeds and statistical analysis relating to various facilities and the handling of materials associated with those facilities. Such items can be provided on a scheduled basis, at periodic intervals, in response to a request in response to a particular event or occurrence, upon the occurrence of certain conditions (for example, a materials accumulation reaching a defined threshold), and so on.

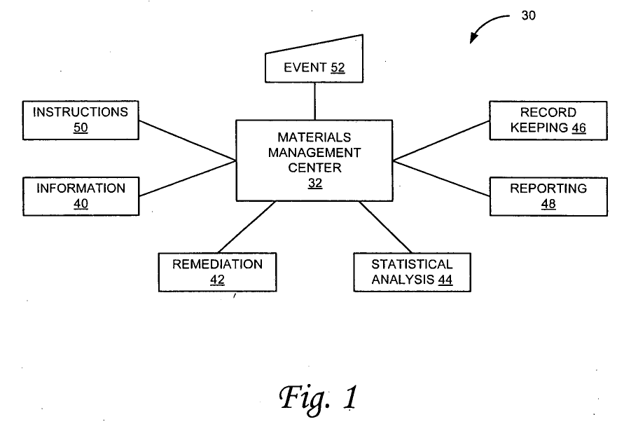

FIG. 1 is a block diagram illustrating an example overview of a materials management system in accordance with one embodiment of the invention. Referring now to FIG. 1, materials management system 30 includes a materials management center 32 that can be implemented to function as the operational engine for the materials management system. Materials management center 32 can be a centralized facility, or any or all of its various functions can be distributed across a plurality of facilities or locations in a geographically diverse manner. Further, the various functions described herein as attributable to Materials management center 32 can be distributed to and among the various facilities it services.

Materials management center 32 preferably includes one or more computers, servers, workstations, or other data gathering, processing, computing and reporting. Preferably, materials management center 32 also includes database or other, data storage, record keeping and retrieval capabilities. Additional details regarding example implementations of a materials management center 32 in accordance with one or more embodiments of the present invention are described in greater detail below.

In operation, materials management system 30 receives an event 52 from a facility or other location that it is servicing. Events 52 can include information pertaining to a material or pertaining to an activity associated with a material at the requesting facility. For example, an event 52 can include information that a particular material is being readied for transit, that a particular hazardous material has been spilled or accidentally released, that a particular material is about to be applied or used in a given application, that a particular material is ready for disposal, or any other event associated with a material. In one embodiment, events 52 deal with materials that may have particular handling, transit, cleanup, disposal, storage or other requirements such as, for example, hazardous materials.

To facilitate a more detailed description of the invention and its various facets, the invention is described herein in terms of a few specific example events 52. After reading this description, it will become apparent to one of ordinary skill in the art how to implement the invention and various of its embodiments and features in responding to handling or otherwise managing any of a plurality of other materials-related events. One such example is that of an accidental spill or release of a hazardous material. In addressing this spill, the facility at which the spill occurred would benefit from information regarding response activities including, for example, techniques and processes for cleaning up the spill, methods for treating the environment in which the spill occurred, proper packaging and labeling of the spilled materials, maintaining accurate records regarding the spill and the various data associated with the spill, and coordinating safe and proper removal and disposal of the spilled materials.

Another example event is that of readying a hazardous material for usage or for shipment in accordance with good safety practices as well as any application federal state and local rules and regulations. These examples are referred to from time to time herein when describing the invention and its various features and functionality. As would be apparent to one of ordinary skill in the art after reading this description, these are merely examples and the invention is not limiting to operating in accordance with these examples.

Additionally, as a further example, events 52 can be automatically generated based on accumulated data such as data accumulated for a given facility. As an example of this, data gathered a particular facility may provide a cumulative total of spilled materials since the last removal event. When the total (e.g., the amount of hazardous waste on hand) for a given material, class of materials, etc. reaches a determined threshold, an event can be generated to schedule removal and disposal of the accumulated materials.

Still referring to FIG. 1, upon receipt of an event 52 (for example notification that a particular material was spilled at a service facility), materials management center 32 queries the appropriate databases and records to determine information about the material and the proper handling of the materials so that appropriate responses can be generated. Additional information regarding the information obtained by materials management center 32 in responding to an event 52 is described below.

Upon gathering the appropriate information, materials management center 32 can generate the appropriate response which can include, for example, one or more of the following: instructions 50; information 40; remediation information 42; statistical analysis 44; reporting 48; and record keeping 46. The responses that can be generated by materials management center 32 are not limited to these responses but can include additional information, actions, and output as would be appropriate for the given application or environment.

Instructions 50 can include information such as, for example, specific information regarding the steps to follow in cleaning up the particular hazardous material that has been spilled, appropriate methods and techniques to store the spilled material, ways to treat the environment in which the material was spilled, methods for treating individuals that may have been exposed to the spilled material, and other like information and instructions. For example, if event 52 indicates that chlorine was spilled at a given facility, the instructions can include information to the facility such as to restrict access to the area until cleanup is completed, that the chlorine can be harmful if exposed to the skin and can also emit a poisonous gas, that the appropriate NIOSH/MSHA-approved full face positive pressure respirator and protective clothing should be worn (which can also be identified in the instructions), and that persons without suitable respiratory and body protection must leave the area. The instructions might also include information regarding the U.S. Department of Transportation (DOT), evacuation and transportation guidelines and the appropriate handling of containerized waste chlorine in accordance with applicable federal, state, and local health and environmental laws and regulations.

In another example where an event is not a spill of a hazardous material but instead the usage of a hazardous material, the instructions might include information on how to safely handle, use and dispose of a particular material. For example, information on whether effective ventilation should be provided, respiratory protection that should be used, eye and face protection that should be used, whether skin protection should be used, whether to avoid eating, drinking, and smoking in work areas, and so on.

Additionally, as yet another example, instructions can include special precautions for material handling and storage of the hazardous materials. For example, the information can include instructions on proper containers in which to store the material, appropriate temperature ranges for the environment in which the material is stored, incompatibility with other materials for storage, proper labeling for storage containers, shelf life or storage limits for the material, and other like information. As these few examples serve to illustrate, a variety of instructions and information can be provided to a requesting facility to provide them with the appropriate instructions for dealing with any of a number of different events 52.

Referring still to FIG. 1, materials management center 32 can also generate information 40 in response to an event 52. Information 40 can include any information that may be relevant or pertinent to a material at a requesting facility. For example, information 40 can comprise a material safety data sheet (MSDS) or other like information for a material being handled at a requesting facility. Continuing with the previous examples of a hazardous material that has been spilled, information 40 might include, for example, a material safety data sheet for the spilled material, appropriate DOT regulations for the transportation of the material, federal, state, and local rules and regulations for dealing with the particular material, site-specific information or instructions regarding the material and its appropriate handling and any other information that may be useful or appropriate in the given circumstance.

Information and instructions in response to an event can be generated or come from data and records maintained by the materials management center. Additionally, such data can be obtained from third-party sources and other external instrumentalities. For example, where a worker may have been exposed to a hazardous material during an event, the system might retrieve information from a poison control center, and the system might patch the poison control center hotline directly to the site reporting the event.

Another response that can be provided by a materials management center 32 can include a remediation response 42. A remediation response 42 can be identification, triggering, or scheduling a remediation activity such as, for example, site inspections, materials removal, materials disposal, inventory updates, equipment or facility replacements and overhauls, and other like activities. Remediation 42 can be in response to an externally or internally generated event 52. For example, where a hazardous material has been spilled, materials management center 32 can also coordinate an appropriate remediation step such as scheduling an outside vendor to conduct the cleanup activities. In another example, where a hazardous waste material is on hand, materials management center 32 can also coordinate an appropriate remediation step such as scheduling an outside vendor to transport the accumulated materials to an appropriate disposal facility.

Thus, in addition to or instead of providing instructions 50 and information 40, materials management center 32 can coordinate the remediation activities with the facility or with a third party vendor or other service provider. In one embodiment, materials management center 32 can include a list of approved service providers for particular materials or classes of materials. Materials management center 32 can also include a list of approved service providers for particular facilities that are being serviced. With the information maintained electronically, scheduling of remediation activities can occur automatically in response to an event 52. As the examples above illustrate, remediation 42 can include transportation and disposal of hazardous materials as well as cleanup activities. Materials management center 32 can automatically schedule transportation and disposal activities with approved or certified vendors, and can send messages or other alerts to appropriate individuals that such events are ready to be scheduled.

For example, the spill of a particular material or class of materials may require immediate cleanup. In the event of such an occurrence, materials management center 32 can automatically schedule the cleanup activity and provide the appropriate notices to responsible individuals. As another example, materials management center 32 can schedule periodic or routine transportation and disposal activities such as those that occur on a regularly scheduled basis. As yet a further example, materials management center 32 can schedule transportation and disposal activities in response to a threshold or other like event. To elaborate, materials management center 32 may in one embodiment track the amounts of material accumulating at a particular facility. This system may be further configured such that when the amounts of material reach a certain threshold, transportation and disposal activities are automatically scheduled to remove the subject materials.

Materials management center 32 can also be configured to gather and to store the data and other information regarding events 52, service facilities, materials managed by the system, various rules and regulations, and other information, as illustrated by record keeping box 46. This information can be used for reporting purposes 48, historical record keeping 46, and statistical analysis 44. Various reports and other output data can be generated as an output of materials management center 32. For example, materials management center 32 can provide routine periodic reporting to the various service facilities for various purposes. As a more specific example of this, quarterly (or other period) status reports, summary reports, detailed reports or other reports outlining some or all of the information associated with the various events 52 can be generated and provided to the service facilities. In addition, as another example, periodic and event driven reporting necessary for government compliance can also be performed by materials management center in an automated fashion. Data and other information gathered during the event handling process can be catalogued for later recall in relational or other databases. This data can be pulled and compiled into reports and other information necessary to comply with various federal, state, and local reporting requirements. As these few specific examples illustrate, automated or semi-automated reporting for various purposes can be managed and effectuated by materials management center 32.

In addition to reporting 48, statistical analysis 44 can also be performed by materials management center 32 using the data gathered. Event information as well as other materials and information can be analyzed on a statistical basis and reports generated outlining the results thereof. Trend analysis, performance analysis, troubleshooting, facility analysis, material analysis, and other statistical analysis can be performed automatically or in response to user requests. As one example, data pertaining to particular events 52 might be correlated to a particular shift or particular worker at a given facility, or might be correlated to a particular type of packaging used for the subject materials. As such, in this example, remedial measures might be taken to change the packaging, update handling instructions for the packaging and so on. The results of the statistical analysis can be included with the reporting function.

Although the events described above in the examples provided refer to external events generated at a requesting facility, events 52 can be generated at any of a number of external locations or can be internally generated based on various factors. For example, events 52 can be generated internally or externally as a function of time—for example, periodic events such as regular reporting requirements, routinely-scheduled inventory events, routinely-scheduled removal and disposal events, and so on.

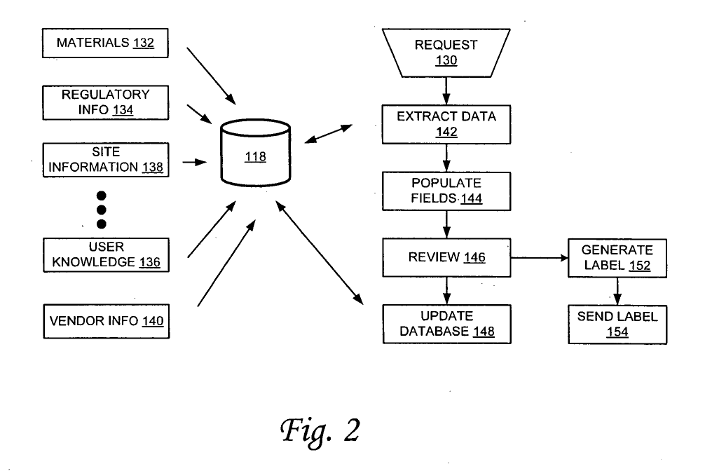

FIG. 2 is a diagram illustrating an example process for responding to an example event in accordance with one embodiment of the invention. As discussed above, one feature that can be provided with a materials management system in accordance with the present invention is the automated or semi-automated generation of hazardous materials information 40 in response to an event 52. One such form of information is a label that can be used for storage of hazardous materials. The example illustrated in FIG. 2 is an example of providing a hazardous materials storage label in response to a spill of a hazardous material.

Referring now to FIG. 2, in a step 130 a request is received from a facility that is handling hazardous materials. For ease of discussion, this will be referred to as a requesting facility. In the current example, the request 130 indicates that a particular hazardous material (or materials) has been spilled at the requesting facility. In one embodiment, the request 130 includes sufficient information to allow materials management center 32 to generate a label for the spilled hazardous material. For example, the request 130 can include information such as the identification of the requesting facility, an identification of the person making or responsible for the request, an identification of the material or materials spilled, and other information that may be useful in responding to the event.

For example, in one embodiment, the materials can be identified by a uniform or universal product code (UPC) or other product identifier to provide some level of standardization across the various service sites. The product identifier can be used as a key or other identifier to provide additional information about the product such as, for example, the specific material involved, the manufacturer, the unit package size, and so on. As another example, the requesting facility identification may be used to identify not only the facility itself, but also to identify the location of the facility (which may be useful in determining which regulations to apply), facility specific handling requirements, designated points of contact and responsible parties and so on.

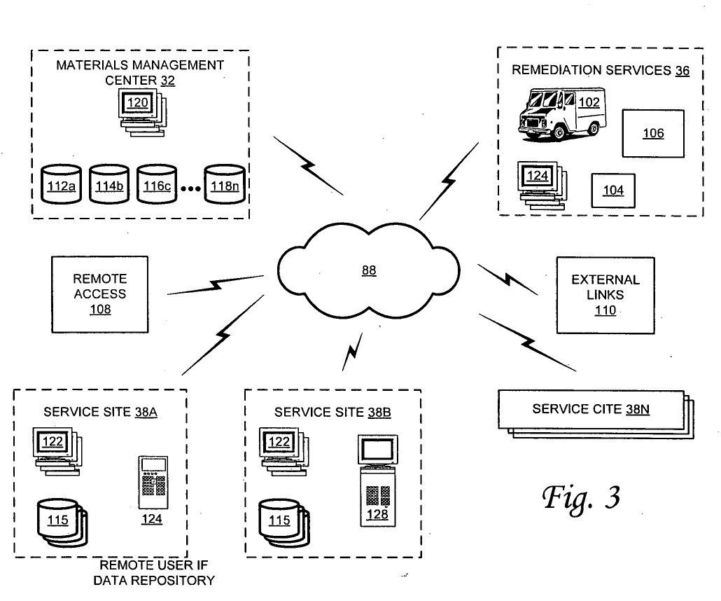

Request 130 can be received via a number of different communication mechanisms including, for example, telephone, fax, and postal service, as well as electronic messaging such as, for example, electronic mail, text message, file transfer, or any other suitable delivery mechanism. As described below with reference to FIG. 3, the various components of materials management system 30 can communicate via any of a number of various communications channels and mechanism.

In a step 142, once the request 130 is received, materials management center 32 extracts the data and other information that will be used to create the requested label. This information can also be used to create the appropriate data record or data records used to maintain an appropriate history of the event for reporting and statistical purposes. For example, materials management center 32 may use the product identifier to obtain more information about the material spilled. As a more specific example, consider a case where the spilled material is a particular fertilizer. In this example, the UPC code may be used to retrieve information that the spilled material is a controlled release 15-9-12 fertilizer manufactured by the ABC fertilizer company and packaged in a twenty pound plastic bag. A UPC may also be used to retrieve information contained on the material safety data sheet for that product in either electronic or machine readable form. As this example illustrates, in this embodiment using the UPC or other product identification, a substantial amount of information 132 about the spilled material can be retrieved to assist in the creation of a label or to otherwise provide information useful for responding to the spill. As an alternative to using a UPC as a key to retrieve information, any or all of the required information can be included in the request from the requesting facility.

In response to the request, 130 materials management center 32 can also extract regulatory information 134 to be used in generating the label. For example, regulatory information 134 can include state, federal, and local regulations outlining procedures and practices for handling the material spilled. In one embodiment, the UPC or other product identifier can be used to extract the appropriate set of regulatory information 134 that pertains to that particular product or to that class of products. For example, in the case of the 15-9-12 controlled release fertilizer described above, materials management center 32 may determine that there are particular federal, state, and local regulations dealing with the cleanup and transportation of the product as well as for the disposal of the product in an approved land fill disposal facility.

Materials management center 32 can also extract site specific information 138 that may exist relevant to the particular service site 38 or class of service site 38 that is making the request. For example, the service site may have particular clean-up, handling, or other requirements used to address materials handling events. As another example, the location of the site may dictate particular local regulations that apply. As still another example, site specific information may dictate the form of the response (e.g., fax, email, etc.), to whom the response is sent, and so on. In one embodiment, the site identification information included with request 130 can be used as a key to retrieve the site specific information 138 used in generating the response to the request.

Although the majority of the information used to generate a label and other material handling instructions is gathered and accumulated in an automated fashion in one embodiment, it is contemplated that there are instances where user knowledge may be used to supplement this information. For example, skilled users trained in handling various materials may be available to provide expertise and guidance in dealing with the particular material that is spilled (or in responding to another type of event). As such, user knowledge 136 can be provided as a component of information that is used in responding to request 130. For example, user knowledge may be entered by an operator via a keyboard or other user input device. The user knowledge may supplement the label, may provide additional handling instructions or other information to the facility, may be used to annotate the historical record, and so on.

Depending on the configuration, the system can also retrieve additional information such as, for example, remediation services information. In one example, various affiliated, internal and third-party vendors and their capabilities can be included in the database to allow the system to identify and even schedule an appropriate vendor for handling the given event. For example, in the event of a spill of a particular material, one or more vendors identified as being certified or approved for handling such spills (for example, cleanup, transportation and disposal) can be identified in the database and their information 140 retrieved in response to the request 130. Thus, contact and other information for these one or more vendors can be included in the response to the request. Additionally, in one embodiment, the system can automatically schedule a vendor from the approved vendor list to conduct remediation or removal activities. As a further example, a service site 38 may identify a preferred vendor or a group of preferred vendors for various services. As such, when that service site 38 is identified in a request 130, information regarding that particular service site's preferred vendors can be retrieved from the database.

In a step 144 with the appropriate information extracted from the various data repositories, information used to respond to the request 130 is populated in various fields. For example, in one embodiment, one or more display screens are provided to an operator and include the extracted information. This information can be reviewed by the user 146 for accuracy and completeness. Additionally, the user can update, edit, or add additional information that may be useful or necessary in responding to the request.

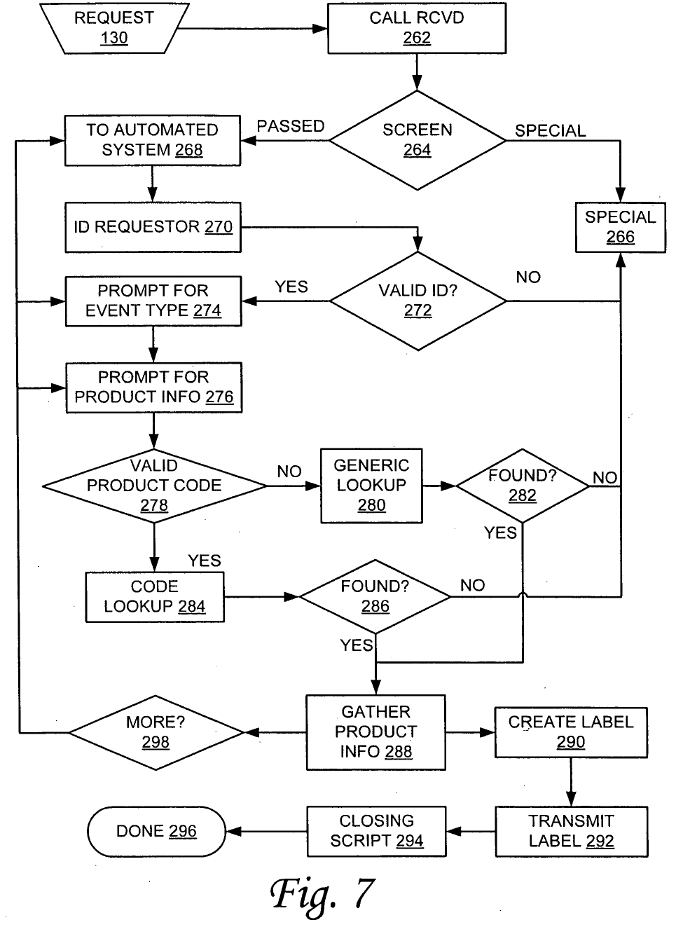

With the information complete, in a step 152 an appropriate label is generated and includes information retrieved in response to the request. An example of such a label is discussed in further detail below with reference to FIG. 7. In a step 154, the label is sent to the requesting service site 38 to complete the response to the request. As stated above, the label can be sent by any of a number of transmission means including facsimile, e-mail, electronic messaging, file transfer, postal delivery, or any other communication mechanism. The label can then be affixed to the bin or other container housing the spilled materials in accordance with applicable regulations.

In a step 148, the materials management center 32 can update one or more databases to maintain a record of the events that transpired. For example, information pertaining to the date and time of the event, the facility at which the event occurred and its location, an identification of the material or materials involved, quantities of materials involved, actions recommended and taken, event closure and other such information can be recorded in the database for record keeping, reporting, and statistical analysis purposes.

Having thus described an example use for the materials management system 30, it is now useful to describe an example configuration of the system. FIG. 3 is a diagram illustrating an example implementation of an overall materials management system 30 in accordance with one embodiment of the invention. Referring now to FIG. 3, the example materials management system 30 includes a materials management center 32 in communicative contact with various other components of the materials management system 30. In one embodiment, materials management center 32 is implemented to provide a centralized management center for providing materials management services, features and functions. In alternative embodiments, the services, features and functions provided by materials management center 32 as described herein can be distributed across a plurality of various facilities or locations as would be apparent to one of ordinary skill in the art after reading this description.

The exemplary embodiment of materials management center 32 is illustrated as including one or more computers or work stations 120 to facilitate operation thereof. Materials management center 32 can also include one or more databases 112a, 112b, 112c-112n to store the various data and other information used in the materials management process. As the above examples illustrate, data can be maintained relating to federal, state, and local rules and regulations governing material handling (including shipment, storage, usage and disposal), material data and information, client specific information and other information used in the process of managing the various materials. Although separate database units are illustrated, data storage can be across any physical or logical data storage architecture, and any of a number of database models can be implemented. In one embodiment, a relational database structure is used to facilitate creation of responses from various separate sources of data.

As stated above, in one embodiment materials management center 32 is configured to provide various facilities with an appropriate response upon the occurrence of one or more various events 52. Examples of a few possible configurations for such requesting facilities are provided and referred to as service sites 38 in FIG. 3. Examples of specific types of service sites 38 can include materials manufacturing plants, shipping and transportation companies, warehouses, retail facilities, factories, and so on. As such, in various embodiments of the invention, materials management center 32 or other like mechanism can be provided to perform a variety of materials management functions in support of these various service sites. For example, a retail store, automobile service facility, warehouse, or other service site 38 may handle various forms of hazardous materials on a daily basis, yet it may not be practical for such a service site 38 to itself maintain the knowledge and other skill sets necessary to properly handle the materials it deals with on a daily basis. As such, materials management center 32 in communication with one or more service sites 38 can provide the services, instructions, information, reporting, and other responses that service sites 38 may use, exclusively or as a complement to their own capabilities, to properly handle hazardous materials in the course of their business.

As stated above, materials management center 32, whether centralized or distributed, can in one embodiment provide materials management functionality to a plurality of service sites 38 in geographically diverse locations. The example illustrated in FIG. 3 depicts service sites 38A, 38B-38N illustrating that multiple service sites 38 of different types and configurations can be serviced by the management center 32 in one embodiment.

Referring still to the FIG. 3, in the illustrated example, two particular service site 38 configurations are illustrated as service site 38A and service site 38B. Each of these example configurations are now described, although other service site configurations are contemplated within the spirit and scope of the current invention.

To better describe a configuration of service site 38A it is useful to describe it in terms of a specific example. Consider the example where service site 38A is a retail establishment that sells various hazardous materials (for example, fertilizers, paints, cleaning supplies, and so on), maintains an inventory of such materials, and may even use such materials for its own purposes as well as for retail sale. Whether the retail establishment is a large national chain or a small, local mom-and-pop organization, most retail establishments include some form of computerization to assist in their retail sales operation.

Service site 38A is illustrated as including one or more computers or servers 122, one or more data repositories 115 and a remote user interface 124. For example, terminals at the loading dock may be used to enter information regarding materials received, while cash registers or other point of sale terminals may be used to monitor the sale of materials from inventory. Each of these systems can be connected to a computer system 122 and data repository 115 to maintain an accurate record of materials inventory and other operations. Computers 122 and data bases 115 may be dedicated devices, configured to perform the materials management functions. In other environments, computers 122 and data bases 115 may be those used for other operations at the retail location that have been provided with the software or other capabilities to perform the materials management functions described herein. Various levels of integration between computers 122, data bases 115 and other facility resources can be provided as may be desired to facilitate operations. For example, a closely integrated system may allow traditional systems such as cash registers to automatically feed information that may be used by materials management center 32 to track materials inventory.

In the illustrated embodiment, one or more remote input devices 124 can also be included to allow remote and portable access to service site computers 122 as well as materials management center 32 (or other aspects of materials management system 30 from various locations in or near the service site 38A). For example, remote input device 124 can be a bar code scanner, RFID tag reader, manual input device (touch screen, keypad, voice recognition, etc.), or other device that enables a user to input information pertaining to a material or materials being handled. Remote input devices 124 are not necessarily limited to hazardous materials management functions, but can also be used in the conduct of other facility operations. In one embodiment, portable terminals currently used by employees at retail establishments to check inventory, check prices, and perform other conventional tasks can also be used to facilitate materials management in accordance with the present invention.

A wired or wireless communication link between the remote user interface 124 and computer system 122 can be provided to facilitate communication between the devices. Additionally, in one embodiment, a direct communication link between a remote terminal 124 and other elements of the materials management system 30 (including, for example, materials management center 32) can be provided as well.

In one embodiment, remote user interface 124 can be implemented as a hand-held, battery operated device with a wireless interface allowing the user with flexibility and mobility of operation. In addition to wireless communications, a hard wired interface can be included including, for example, a docking station, cradle, or other like device to allow the remote user interface to be charged as well as to transfer data to other components within the materials management system 30.

To better illustrate the functionality that can be included with a remote terminal 124, consider an example where a material such as a fertilizer or other hazardous material is spilled within the retail sales facility. A worker at the retail outlet can use the remote user interface device 124 to input information regarding the spill or to retrieve instructions and other information that may be useful in dealing with the spill. For example, the remote user interface device can be used to scan a bar code, RFID tag, or other product identifier to enable identification of the material in question. Alternatively, the user can key-in or otherwise manually enter information pertaining to the product that was spilled.

As described above, in one embodiment a UPC can be used to identify the product. In an implementation of this embodiment, the UPC can be used as a code to retrieve additional information about the product, regardless of whether such retrieval will be performed at the service site 38, at materials management center 32 or at some other location within or associated with materials management system 30.

The user at service site 38A can also enter additional information into remote user interface 124 or other interface. For example, the user may enter the type of event 152 that is being registered. In the case of the current example, the user would identify that the material in question has been spilled and this would result in an event 52 being generated being sent to materials management center 32 for an appropriate response. The event may be generated either automatically, or in response to further user input. Additionally, alerts or other messages can be sent to appropriate personnel in addition to or as a part of event 152.

As discussed above, the appropriate response can include responses such as instructions 50 regarding how to deal with the event, information 40 pertaining to the event and the materials involved, scheduling or coordination of remediation 42 and other activities and other like responses as described herein. In terms of the example described above with reference to FIG. 2, one appropriate response is to generate a label that can be used for the storage of this spilled material upon clean up. In furtherance of this example, the appropriate label can be sent to the service site 38A following any of the transmission methods outlined above. The label can be retrieved by the requestor or other appropriate personnel and properly affixed. As the above examples illustrate, the label may be printed from a terminal 122 (e.g., such as where it was sent via email or electronic message), retrieved from a fax machine, or otherwise appropriately obtained. Additionally, the label may be printed at remote user interface 124 where such capabilities are provided.

Of course, remote user interface 124 is not limited to functions associated with the example of creating a label as described above. Indeed, remote user interface 124 can be used to facilitate the event generation and response delivery in any of a number of different types of events for various scenarios and operations. A screen can be provided on remote user interface 124 to allow this system to display step-by-step instructions to the user regarding how to handle a particular event (such as, for example, cleanup instructions), safety instructions, material handling instructions, and so on. Additionally, a remote user interface 124 can be used to track the movement of materials throughout the material handling process. For example, when a spilled material is tendered to the appropriate transporter for removal and ultimate disposal, that event can also be logged by remote user interface 124.

To illustrate yet another example configuration of a service site 38, reference is now made to service site 38B were in a kiosk 128 is provided to assist with the materials management function. Kiosk 128 can be used in addition to or in place of a remote user interface 124 or other input device. Kiosk 128 can provide a walk-up terminal in one embodiment that allows a user to perform materials management functions such as, for example, generating events and receiving information, labels, instructions, and other responses from the materials management center 32.

Although two exemplary configurations for a service site 38 have been provided, these examples will serve to illustrate to one of ordinary skill in the art after reading this description that other configurations and architectures for service site 38 can be implemented to achieve the features and functions of the materials management system 30 as described herein. Additionally, the materials management system 30 can be implemented in such a way as to be scaled to handle a large number of various and diverse service sites 38.

The various elements of materials management system 30 may also include various communication components to enable communications among themselves as well as with outside entities. For example, communications interfaces to enable communication across network 88 or other communication channels between and among the various material management system components can be provided. The depicted example illustrates a communications interface implemented via a network 88. Although a single network cloud is depicted in FIG. 3, communications among the various elements of materials management system 30 can take place via any of a number of different communication channels or mechanisms, and are not necessarily confined to communication across a single local or wide area network. For example, communication elements such as the internet, the public switched telephone network (PSTN), other public and private networks, cellular links, satellite links, and other communication channels can be used alone or in various combinations to provide the elements of communications between and among the various components of materials management system 30. Thus, it is not necessary that all communication among the elements flow through a single communication network.

Additionally, materials management system 30 can include one or more appropriate remediation services 36 to provide remediation supplies and services to the various service sites 38. For example, as illustrated in FIG. 3, a hazardous materials transportation and disposal service 102 may be included to provide specialized transportation of hazardous materials in accordance with applicable rules and regulations. Such services can be provided by either independent operators, or operators who are somehow affiliated with materials management center 32, or one or more service sites 38, for example.

In one embodiment, remediation services 36 include transportation and disposal services 102 that can be used to remove hazardous waste from a requesting facility, transport hazardous materials from one location to another, and otherwise provide materials transportation services. An additional example of a remediation service 36 is a cleanup service 106. These and other remediation services can be managed by materials management system 30. More particularly, in one embodiment, they can be managed and scheduled utilizing materials management center 32. As described above, in one embodiment the scheduling of such resources can be performed automatically by materials management center 32 in response to various threshold monitors and triggering events.

In one embodiment, where remediation services 36 are provided by outside vendors, an approval or certification process can be implemented to ensure that appropriate services are provided for a given event. For various vendors, various levels of certification may be available when approving vendors for certain of the provided services. For example, government licenses, government and private-party certifications, service site approval, and materials-management-system certifications, to name a few, can be required to qualify or certify particular vendors.

As a further example, vendors may be required to have certain levels of experience, particular training and expertise, particular equipment and materials, in-depth knowledge the workings of materials management system 30 (at least as it relates to the vendor), the ability to properly tie into the system to share data, and other levels of skill, training, and experience. Thus, a given level of performance, experience and expertise can be required from the various remediation service providers to be approved by the system. In addition to levels of certification, various vendors may be placed on lists for various service facilities. For example, a particular service facility may maintain a list of its own vendors that it prefers to deal with for particular services or functions. In one embodiment, services sites 38 are provided with the ability to maintain and update their own vendor service provider lists for various services and functions such that materials management center 32 can schedule remediation resources based on approved vendors. Vendors and the various lists can be ranked in order of preference as well to enable prioritization of the choice of vendors.

Remediation services 36 can also be provided with remote user interfaces such as, for. example, a remote user interface 124, or similar device. Remediation services 36 can also be provided with certain access to kiosks at service sites 38, their own computer interfaces, or otherwise access to the IT infrastructure of materials management system 30. The level of access may be appropriately restricted to allow the remediation services 36 to have the ability to obtain, edit and create only that information used for scheduling, performing and reporting the service. In other embodiments, remediation services 36 can be granted full access to the system or other partial access as may be deemed appropriate for the particular service provider or for the event to which they are responding. Thus, in this way, remediation services 36 can operate as an integral part of materials management system 30.

For example, service requests to a remediation services provider can be provided electronically by via e-mail, text messaging, electronic messaging, or other electronic means to provide scheduling requests to a desired service provider (although other communication mechanisms can be provided as well). Service requests can include detailed information about the service to be performed such as, for example, a service location (for example, at a requesting facility) the type of services to be performed., the materials involved, and a schedule for completing the services.

To better illustrate this point, consider an example where a remediation services provider is called to remove a plurality of hazardous waste materials from a particular service site 38. In making the request, materials management center 32 can provide a copy of the request to the desired remediation services provider 36 as well as to appropriate personnel at the affected service site 38. In this example, the request can also include a complete listing of materials that the vendor is to pick up at the service site 38 for removal and disposal. Thus, the service provider's schedule and shipping manifest along with other pertinent information can be provided electronically along with the request.

The contacted service provider can accept the request to confirm the appointment. Upon arrival at the designated service site 38, the vendor can log the materials that he or she actually receives for transportation and disposal. For example, a portable device such as a remote user interface 124 can be used by the remediation service provider to scan in each item that is picked up for removal, although manual or other automated means can also be used to log materials. As the items are scanned in, or otherwise entered at the kiosk, remote user interface, or other terminal, the items verified as picked up for transport can be cross checked against the inventory list, manifest, or other data to ensure that there is correlation between the requested task and that which actually occurs. Similar logging and checking functions can occur at the disposal site as well. As such, with electronic entry and monitoring of the transportation and disposal process the system can track whether each of the items have been properly handled and accounted for. This information can be used in the recordkeeping, statistical analysis, and report generation functions to facilitate and enhance the functionality of the system.

Also illustrated in FIG. 3 is a remote access site 108. One or more remote access sites 108 can be provided to allow various users to access the materials management system 30 from one or more remote locations. Thus, persons with the proper levels of clearance or authorization may be granted remote access privileges to the materials management system 30. Such remote access may provide the capabilities to, for example, monitor materials management activities; gather information about the materials management process, including various events and responses; conduct operations, and otherwise access the features and functionality of the materials management system 30 from a location outside of the system.

For example, a user may be provided with access information to log onto the materials management system from his or her home, from on the road, or from some other remote location. Such access may be via numerous mechanisms such as a personal computer or laptop; a PDA, smartphone or other handheld computing device; a telephone; or other appropriate interface mechanism. As such, personnel may maintain contact with the system from various locations. For example, managers or other appropriate personnel from a service site 38 may be able to log on to the system to monitor operations affecting their facility (including real-time monitoring), generate needed or useful reports, review data, reports and statistics, and other like operations.

As the example depicted in FIG. 3 illustrates, various external links 110 can also be provided to allow the materials management system 30 to access additional information that may not otherwise be contained within its databases. For example, external links to federal state and local rules (to obtain updates, for example), product information, UPC codes, MSDSs, and other external information may be accessed to allow the system to maintain currency of the data, add additional data and otherwise ensure sufficient information used in performance of the materials management functions.

As described above with reference to FIG. 2, one of the responses that can be provided by materials management system center 32 is that of creating and sending an appropriate hazardous waste materials label in response to a material spill. In one embodiment, sufficient information may be contained within or otherwise accessible to materials management center 32 (or other elements of materials management system 30) to allow creation and transmission of the label in an automated fashion without user intervention. However, in another embodiment, user intervention may be provided to either furnish additional information that may not be available to materials management system 30, or to ensure accuracy and completeness of the information retrieved by the materials management center 32.

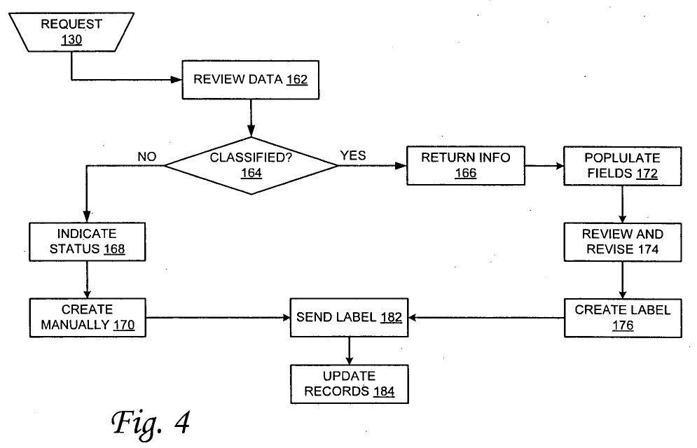

FIG. 4 is an operational flow diagram illustrating an example process for creating a label with at least some level of human intervention in accordance of one embodiment of the invention. Referring now to FIG. 4, a request 130 is received by materials management center 32. In keeping with the example described above, request 130 is a request of a hazardous materials label that will be used in conjunction with hazardous material that was spilled and subsequently cleaned up at a requesting facility. The data from the request is entered into the materials management center 32 such that information can be retrieved to generate the label. In electronic embodiments where the request is sent in electronically, the information can be performed automatically by a simple data look ups or other techniques. Alternatively, where the request comes into materials management center 32 via facsimile, phone call, or other manual mode, human entry of the data may be required.

In a step 162 the data contained in the request is reviewed to determine information such as the material identified as the spilled material. In a step 164, the system determines whether the material is classified within the system. That is, in one embodiment the system can check to determine whether sufficient information is contained within the various data stores to accurately generate a label to respond to the request. If the material is not classified, this status is indicated to an operator in a step 168, and an appropriate individual is tasked with manually creating the information needed for the label as illustrated by step 170. In this manual creation step, a form or other like window can be presented to the user a user terminal such that the user can enter the appropriate information into the form to thereby create the label.

Certain information for the form may be pre-populated depending on the availability of such information. For example, where the request is generated by an existing service facility, that facility's identification information may be pre-populated in the form. Additionally, where the material is of a particular class of materials and information is known about that class of materials (even though information may not be known about the particular material) such information may also be pre-populated. Still further, where information is known about the material, but additional information may be required or desired, such known information may be pre-populated. The user can review the pre-populated information and make any edits or adjustments as necessary and fill in any additional information that is necessary or useful to complete the request. This information can be provided based on the user's knowledge and experience in the field and in dealing with particular materials. Additionally, links and other access to internal and external data repositories can be provided to the user such that the user can perform any research that may be necessary or useful in completing the request. Once the request is completed and checked by the user, a label that can be created and in a step 182 sent to the requesting facility.

If on the other hand, the material that is the subject of the request has already been classified as indicated by step 164; the materials management center 32 automatically returns the information necessary for responding to the request in a step 166 and populates the fields 172 in the forms that will be used for the response. In a step 174, the populated form can be reviewed by a user and revised as appropriate. In response, a label is created in a step 176 and sent to the customer in step 182. To ensure completeness of the data in the system, records can be updated in a step 184 to reflect the transaction.

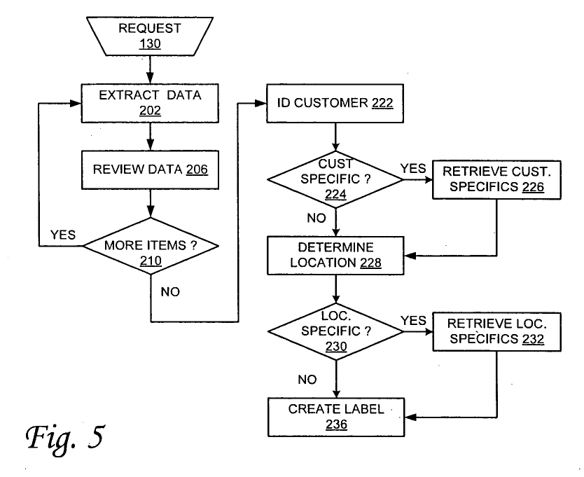

FIG. 5 is an operational flow diagram illustrating an example process for creating a label in response to an event in accordance with one embodiment of the invention. More particularly, the example illustrated in FIG. 5 depicts additional features that can be provided in the process of responding to events and particularly in terms of the example of label creation. After reading this description, it will be appreciated by one of ordinary skill in the art how the processes depicted in and described with respect to these example figures can be implemented with other events and other responses. Referring now to FIG. 5, in step 202 the data included with the request is extracted. This extraction can take place in one embodiment as discussed above with reference to the example in FIG. 4.

In a step 206, the data is reviewed to determine whether there is more than one item of material that needs to be addressed. This can be useful, for example, in the context of spilled hazardous materials, as the mixing of multiple hazardous materials may result in a different set of conditions than the spillage of either one of the materials and thus may require different handling techniques, precautions and procedures. If there is only one item of material in the spill report as indicated by decision step 210, the process can continue with creating the label. If on the other hand, however, there are additional materials included in the request, additional data may need to be extracted and reviewed to determine the appropriate manner in which to handle the combined materials.

Additionally, communications back to the requesting facility may be conducted to obtain additional information about the spill. For example, it may be useful to determine whether the multiple materials have been co-mingled in the spill process or whether in fact they are spilled at different and separate locations at the facility yet included in a single request. In some cases, where multiple items are involved, manual intervention may be warranted to better create the appropriate response to the situation. This is because there may be combinations or conditions that are not accounted for in the various data bases.

Although label creation can take place at this point in the process, FIG. 5 also depicts additional features of the invention that can be used to provide customized response parameters based on information in the request. The example illustrated in FIG. 5 depicts the use of customer IDs and customer location to customize the response. Thus, an identification of the customer or the facility requesting the response is determined in a step 222. As discussed above, this identification can be made based on a facility ID or other information included in the request. For example, in Internet, networked or other computer implemented environments, login information, an IP address, cookies or other computer or terminal identification techniques can be used to identify the requesting service site 38 and, in some implementations, the particular user initiating the request 130. As another example, in applications where a telephone link is used to access the system, ANI (automatic number identification) or other caller-ID-like services can be used to identify requesting service site 38 and, in some implementations, even the particular user initiating the request 130. Additionally, service sites 38 and their employees may have assigned call-in numbers so that this information, via DNIS (Dialed Number Identification Service) or otherwise, can also be used as a mechanism for such identificiation. As these examples illustrate, there are various techniques that can be used to identify the site and personnel initiating the request.

Based on the identification, in one embodiment, information can be captured including for example, the name, employee identification number or other identifciation of the person initiating the request; an identification of the service site 38 from which the request was received, which can include site specific as well as chain, franchise, or other like affiliated identification; geogrpahic location of the requesting site 38; contact information for the person requesting the label, the department involved with the event, or a service department of the site 38; and return information for the label or other response, including for example, fax number, e-mail address, IP address, mailing address, or other information regarding return of an appropriate respsonse.

In a step 224, the system can then determine whether there are customer-specific requirements or instructions that are to be used in preparing the response. For example, a customer may have particular reporting requirements to report spills or other events, a customer may have specific clean up, evacuation, or other procedures that are more stringent than those required by federal, state and local rules and regulations, and so on. If customer-specific requirements exist, those specific requirements can be retrieved and used in generating the label or other response.

In a step 228, as alluded to above, the location of the event is also determined. In one embodiment, the location can be determined based on the customer identification. That is, in some embodiments, the customer identification may be specific to a customer location even where the customer is a large national or multi-national customer. For example, customer IDs can be tied to particular sites and even particular departments or locations within a site.

In another embodiment GIS (Geographical Information System) information and data conventions (also known as geo-codes), or other like conventions, can be used as for identifying a service site or event location. In such embodiments, the systems can be implemented so as to provide storage, retrieval, mapping, and analysis of geographic data. Spatial features can be stored in a coordinate system (latitude/longitude, state plane, UTM, etc.), to reference a geographic location on the earth. Descriptive attributes in tabular form can also be associated with spatial features. Spatial data and associated attributes in the same coordinate system can then be layered together for mapping and analysis.

The location, as with other information gathered in the course of responding to an event, can be linked to the event and associated records. Whether it is address information, latitude/longitude information, geocodes, or otherwise, such information can be stored, associated with the event, and utilized in generating the response. This information can be used in a number of ways, including, for example, for crafting an appropriate location-specific response, directing a response team to the correct site for action (clean up, removal, attending to injuries, and so on), performing statistical analysis, record keeping and reporting.

Once the location is determined, the system determines whether there are location-specific rules, regulations or other instructions that need to be applied in responding to the request. This is illustrated by decision step 230. For example, state and local authorities often have different requirements for dealing with particular materials than their neighboring states and localities. Therefore, it is useful to determine whether and which particular regulations may apply in a given circumstance based on the location of the event. It may also be important to determine the location of a receiving site in the circumstance where the event is the transportation of the material from a first location to a receiving location. In this way, requirements for each location can be determined.

If there are location-specific requirements or other location related information, those requirements and that information are retrieved in a step 232 and applied to the label generation process. Then, in a step 236, the label can be created for transmission to the customer.

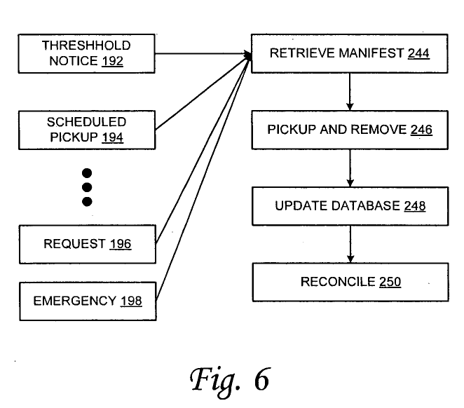

FIG. 6 is a diagram illustrating an example process for transporting hazardous materials from a location in accordance with one embodiment of the invention. Referring now to FIG. 6, to begin the transportation process, in one embodiment the entity responsible for transportation receives a notice that there are materials to be picked up and removed. As discussed above, the generation or creation of a notice can occur based on a number of different events. For example, a threshold notice 192 might be generated in response to accumulated levels of particular materials of classes of materials reaching a determined threshold at a particular location. Such thresholds may be determined based on facility particular requirements or based on federal, state and local rules and regulations, or based on other factors.

In another embodiment, a transportation event can be generated based on a scheduled pick up time 194. For example, a requesting facility (for example, a service site 38) may have a pre-defined schedule of pickups for the removal of hazardous materials from that facility. Such pickups can be scheduled at regularly occurring intervals and the scheduling notices generated automatically based on calendaring systems or other like processes. User intervention can be provided to advance or retard the scheduling process in accordance with real-time situational changes.

In another embodiment, a user-generated request 196 can be used to trigger the transportation event. For example, a facilities manager or other appropriate personnel at a requesting facility may determine that it is appropriate to have particular materials removed from the facility at a given time and may generate an appropriate manual request. The request can be entered by any of a number of different means including, for example, a remote user interface 124, a kiosk 128, a service site computer system 122, a telephone, fax, text message or other message, or other communication means.

As yet another example, an emergency situation 198 may arise triggering a transportation event request. For example, a spill or leak may occur triggering an automated alarm system a part of which generates an automated request for remediation. For example, particle sensors and other, chemical detectors, and other like systems can be used to automatically detect the presence of certain hazardous materials. Such detection can automatically trigger an alarm triggering a remediation event such as, for example, a transportation event. As these examples illustrate, there are a number of triggers that can be implemented to facilitate the occurrence of a transportation event (or other event as may occur in the system).

Upon the occurrence of an event, the materials transporter retrieves a manifest as illustrated by a step 244. This can be downloaded automatically along with the event, or the material transporter can access the system to download the manifest. The manifest can include information such as the scheduled time, date and location of the pickup, as well as a complete inventory list of the materials to be retrieved.

In response, in a step 246 the transporter arrives at the site to pickup and remove the listed materials. The transporter checks the materials as they are being loaded into the van or other vehicle, which can be done via manual input or automated scanning devices. As a result, appropriate databases can be updated in a step 248, and the information reconciled with the original manifest to determine whether all of the appropriate materials were picked up for transportation. As noted above, the transporter can enter the information into a hand-held remote interface or other terminal device such that the reconciliation can occur automatically. In one embodiment, the reconciliation can occur at a client device used by the transporter and later downloaded to the system servers. In another embodiment, the data is updated as it is collected at the central server and the reconciliation taking place there.

As with the other events described herein, the appropriate databases can be updated such that historical analysis, statistical analysis, recordkeeping and reporting abilities can be maintained. Although FIG. 6 describes the operations that can occur when the event requests the transportation of hazardous materials, this example serves to illustrate how similar events can take place to schedule the cleanup or other remediation activities as well as other system events such as reporting.

As the above examples illustrate, a telephone system can also be used to allow personnel to call in requests 130 via automated (or even person-to-person, or live) telephone interfaces. For live interfaces, an operator or other service personnel can receive the call from the requesting service site 38 and provide the interface to computerized systems used to generate or facilitate generation of the appropriate response. One example of an automated interface is now described with reference to an example implementation. FIG. 7 is a diagram illustrating an example implementation of an automated telephone interface that can be used with a response system in accordance with one embodiment of the invention. More particularly, FIG. 7 illustrates an example implementation of automated telephonic interface used to respond to a request for assistance with a materials spill. After reading this example, one of ordinary skill in the art will understand how to utilize an automated telephonic interface for other events and in other applications.

Referring now to FIG. 7, in a step 130, a request for assistance with the example material spill is made. In accordance with this example telephonic interface in this example implementation, a user at a surface site initiates a telephone call to a materials management center 32 to report the material spill and to obtain additional information. In this example, the response generated can be instructions for dealing with material spill, a label used for labeling the clean-up materials, or other appropriate response information. These embodiments contemplate the use of conventional telephones, cellular telephones, satellite telephones, radio telephones or other telephonic instruments, including PDAs, smart phones and other electronic devices with telephonic capabilities. As a further example, in an implementation where a remote user interface 124 is used, the remote user interface can be provided with cellular or other telephonic capability which can be used in this embodiment.

In a step 262, the call is received at a call center or other appropriate reception point. In this embodiment, the call center is an automated call center configured to handle numerous incoming requests for services utilizing a fully or paritally automated prompting and response system. In one embodiment, multiple incoming phone lines can be used and one or more lines designated for or dedicated to particular services, particular types of requests, or particular service sites 38, departments or personnel at service sites 38 and so on. Thus, DNIS or other like mechanisms can be used to identify the service site 38, personnel making the call, the type of request, the desired response, or other information based on the telephone number to which the call was made. Additionally, ANI or other like services can be used to identify the requesting service site 38, the personnel making the call, or other like information based on the information about the originating call. Still further, the caller can be prompted to enter (speak or key in via keypad) location and identification information in any of various formats. For example, the caller may be prompted to enter an account or ID code and a security code, from which identification and location information can be determined.

In a step 264, the call is screened. For example, in one embodiment, it can be determined whether the call is coming in from an authorized or recognized service site 38 based on ANI or other like mechanisms. If the call is not coming in from a recognized subscriber, a script or other response can be provided to the caller telling them they have reached this number in error or asking for additional information (for example, to key in subscriber or ID information). As another example, screening in step 264 may indicate that the caller has an out of date account or other information that requires updating. In this case, the caller can be transferred to a customer service representative or otherwise rerouted to verify and update account information or scripts can be used for automated updating and verification. In one embodiment, a by-pass can be provided such that remedial action can be taken in event of emergencies, bypassing or putting off the update process.

As still a further example, screening step 264 can screen for emergency conditions that may require additional or alternative responses other than generating a materials label or providing clean-up instructions. For example, the screening step can query the user regarding whether an injury occurred, medical treatment required, or other circumstance they may require immediate attention or alternative treatment. Thus, in one embodiment, the system can transfer the caller to a live operator or to a 911 response center depending on the response required.

As these examples, illustrate, there a number of scenarios or circumstances that can be screened in step 264 to determine whether special conditions exist and special services or assistance offered in step 266 are useful or necessary. As these examples also illustrate, special or alternative response and handling as illustrated by block 266 can take on many forms, included automated handling, live operator interaction, call forwarding, and so on.

Where no special services are requested or deemed appropriate (or after or in parallel with the special services being rendered), the call can be passed to the automated system to as indicated by block 268 to generate the requested materials label and other information.

In a step 270, the identification of the requestor is verified. In this step, the system can be implemented to prompt the caller to provide or confirm the facility and caller identification. For example, the caller may be requested to enter identification code, PIN code or other identifier by a telephone keypad or voice recognition to confirm his or her identification. As another example, a script might be read or played to a caller stating the identification and location that the system has ascribed to the caller based on ANI, DNIS or other techniques, and the caller can be requested to confirm this information. As yet a further example, where information may not be complete based on ANI, DNIS or other information, the caller may be prompted for additional information such as service site identification (client or business unit, facility number, facility local); caller name, caller phone number, caller fax number, or other like identification. As would be apparent to one of ordinary skill in the art reading this description, such information can be entered using the telephone keypad and audible menus and other prompts and mechanisms can be provided to the caller to assist them in entering the information.

In one embodiment, the system can also request a tracking number from the service site 38 such that the event can be tracked through the system and reported with some form of identification. In other embodiments, a tracking number may be assigned to their request by the materials management center. In yet another embodiment, the events can be tracked or reported based on service site or system identifiers.

If the information entered is not valid as determined at block 272, the call can be transferred for special handling either by a live assistant, or through other means at block 266. Alternatively, the call may fail at this point and the caller be disconnected.

In a step 274, the caller can be prompted for event type or other such information. In terms of the present example, the caller could respond that the event type is a material spill and provide additional information about the assistance requested. The system can prompt for additional information that may be useful in responding to the event. For example, the system can query the user regarding whether there has been blood spilled, where the spill occurred, what the whether conditions are (some spills may apply different handling based on the environment in which they occur) or otherwise query for additional information based on the event type. As a further example, in one embodiment, a tree structure can be used to walk the system and caller through the appropriate queries and responses based on event type and based on subsequent responses.

In a step 276, the system can be configured to prompt for product information such as material identifier, quantity involved in the event (e.g., amount spilled), and so on. The system can be configured to identify the product or material that was spilled and thus provide tailored responses to the requester. For example, in one embodiment, the system can prompt for a UPC (Uniform Product Code), site-specific or customer-specific code, product name, product description, product class, or other information that might be used to identify the materials involved in the spill. As described above, the responses can be numeric or alpha-numeric (for example, via the touchtone keypad) or spoken through the use of speech recognition. As described above with reference to step 274, additional queries can be made for additional information as may be deemed appropriate based on the information provided.

In a step 278, the system can be configured to perform a look-up or other operation based on the entered information to determine whether the material or product code exists in the database. If the information is not found, in a step 280, the system may prompt the user for additional information or to retry the entry. If the entry is still not found as illustrated by a step 282, the user can be forwarded to customer service, or prompted for additional information. If however, the material or product is located in the database, the operation can continue at a step 288 where product information is gathered. Additionally, if the information is located, the user can be asked to verify the identification of the material or product searched.

Returning now to step 278, if the product code or other identifier is validated, in a step 284, the system can retrieve information regarding the material or product identified by the requester. If the material or product is not located as illustrated by step 286, the user can be returned to customer service or prompted for additional information. If the material or product is located, the user can be prompted to verify the selection.

Once the material or product is located, in a step 288, the system can gather information associated with the product in responding to the request. For example, such information can be gathered as described above to allow the system to assemble the appropriate responses including clean-up instructions, materials labels, and other response items that the user may request.

In a step 298, the system can be configured to prompt the user to enter additional information that may be useful in assembling a response or otherwise responding to the request. For example, where more than one material is involved in a spill or other event, it may be useful to have information on all of the materials before a response is generated. Thus, in one embodiment, the system can prompt the user to enter information about other materials or products that are involved in the event. In one embodiment, where certain information is gathered, this may lead the system to prompt for additional information based on the previously entered data.

In another embodiment, the system may prompt the user to enter information about additional events that may have occurred and whether they are related or unrelated to the current event to which the system is responding. In one embodiment, the system may put a limit on the number of events or responses that can be handled per call and check to see whether the limit has been reached before allowing further entry.

In one embodiment the system can be configured to determine whether the additional information modifies the response to the original request and whether an additional response is required. For example, where two materials are mixed in a single spill, special or additional instructions or other responses may be warranted. Thus, for example, there may be a circumstance where label creation (290) or other response is not generated or transmitted until the additional information is obtained and considered. The system can also be configured to determine whether the additional information warrants special treatment. As an example, a spill of multiple materials may result in dangerous conditions such as, for example, a combined spill of muriatic acid and chlorine. Therefore, in one embodiment, the system can be configured to immediately forward the call to a live specialist, provide immediate responses or warnings, or to direct the caller to other resources (e.g., poison control, 911, etc.) to handle the special circumstances.

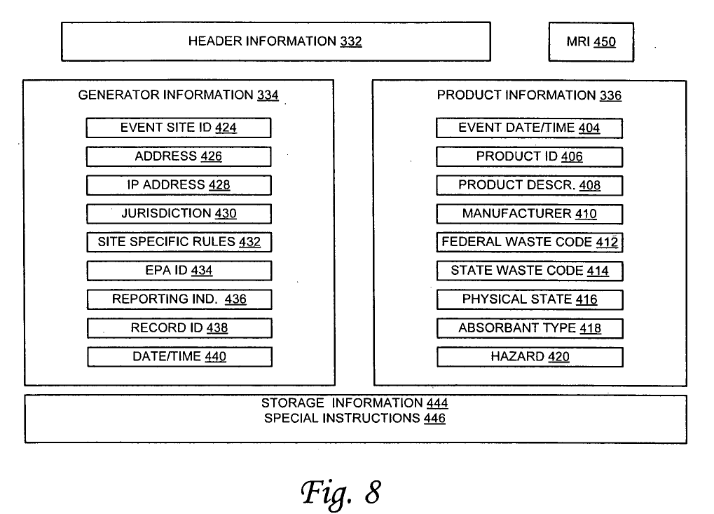

In a step 290, with data on the material on the event, the appropriate response can be generated. As discussed above, the example described herein involves the creation of a materials label to be used for spilled materials. Thus, in this example, in step 290, a materials waste label is generated, an example of which is provided in FIG. 8.

In a step 292, the generated label (and any additional response information) can be transmitted to the requestor at the appropriate location. For example, as described above, the information can be transmitted via facsimile, mail, text messaging, the internet or other network, or any other means as may be useful or appropriate for transmitting requested information.

In a step 294, a closing message or script can be played to the caller to appropriately terminate the session. Additionally, the caller can be prompted to verify any information provided or to be given the opportunity to enter any additional information into the system about this or other events. Furthermore, the closing information can provide instructions to the caller about how to receive the requested information. For example, the caller may be instructed to go to a particular fax machine to retrieve the response, to log on to a particular website or otherwise be instructed how to retrieve the generated information. Additionally, the closing script can provide instructions to the user for applying the generated label.

In a step 296, a call can be terminated thus ending the session. As discussed above, the system can be configured to maintain records and other information surrounding the event and response for historic, record keeping and statistical purposes.

As some of the above examples illustrate, one use for the materials management system 30 can be to generate hazardous materials labels in response to materials spills.

FIG. 8 is a diagram illustrating an example layout for a materials label in accordance with one embodiment in the invention. In a preferred embodiment, the label can include the elements of information that are mandated by applicable federal, state, and local regulations as may be in effect from time to time. Additionally, the label can include other information that may be desired or mandated by the requesting facility, by the materials management center, or by another entity, or other information that may be deemed appropriate in responding to the particular event.

Referring now to FIG. 8, the label can include header information 332 to provide identifying or title information about the label. For example, in one embodiment, the header information can include the words “hazardous waste” in large or boldface type, and can also include a notation that state and federal law prohibits improper disposal. The example label illustrated in FIG. 8 includes both the generator information 334 and product information 336. In the illustrated example, these two types of information 334, 336 are listed in separate boxes. Generator information 334 can include information about the service site 38 or other like facility that is reporting the event and requesting a label. For example, generator information can include information such as an event site I.D. 424, a facility address 426, an IP address 428, jurisdictional information 430, any site-specific rules 432, an appropriate EPA I.D. No. 434, an identification of the reporting individual 436, a record I.D. 438, a machine-readable label 450, and date and time information 440 regarding the occurrence of the event. These items described with reference to FIG. 8 are provided for example only and additional or alternative information can be provided with the label.

Event site I.D. 424 can identify the service site 38 or other facility that is reporting the subject event. This can include a facility name, an identification number, (alphanumeric or otherwise) or other identifying information. Address 426 can include a full mailing address or other location information pertaining to the subject site. Additionally, location information can include a GIS geo-code or other like identifier. An IP address 428 or other like electronic address or information (for example, fax number, phone number, or other contact information) can be provided to identify one or more means for contacting the subject facility, as well as one or more means for delivering the label to the subject facility.

Jurisdiction information 430 can include information pertaining to the location of the event, which in turn may indicate the federal, state, local or other rules or regulations that may apply based on the jurisdiction of the subject site. Additionally, site specific rules 432 can indicate particular rules, requirements or other conditions that may be imposed on the event based on facility-specific requirements. The EPA I.D. 434 is a field that can include an EPA identification number for the event. The reporting individual 436 can include information pertaining to the person or persons who generated the event. Additionally, a record I.D. 438 can be assigned to provide identification and tracking of the event, and more particularly, in one embodiment, tracking of particular activities or records within the event.

Note that the information included with the generator information 334 is generally described above as that information associated with a site at which an event occurs. This information can also include additional generator information related to the generator entity as well as the event location. For example where a generator entity is a large corporation having multiple locations, such an entity may have a central office having overall responsibility or oversight requirements for particular events at various locations. In such situations, in addition to event site information, address, contact and other information for the central office (or other location) can also be included.

Examples of information that can also be included in the product information portion 336 of the label are also illustrated. An event date and time 404 can be included to show the date and time of the occurrence of the event. A product I.D. 406 can also be provided to identify the product involved in the event. For example, a UPC or other product identification code can be provided as product I.D. 406. A product description 408 can also be provided to identify the product by its common name or other description. For example, this field can include descriptive terms such as propane, fertilizer, ethanol, or other like plain language descriptor of the product involved. Additionally, a manufacturer identification 410 can also be provided to identify the manufacturer, supplier or other originator of the product involved in the event. To further identify the product, physical state information 416 can also be included such as, for example, whether the product involved is a solid, liquid, or gaseous product.

Federal Waste Codes 412 and State Waste Codes 414, as may be applicable, may also be included in the product information 336 section of the label. Where applicable, an absorbent type 418 can be included as can information pertaining to the hazards 420 that may be presented by the particular material involved in the event. Additionally, storage information 444 and special instructions 446 can also be included where appropriate. For example, storage information 444 can identify particular storage requirements for the hazardous material involved in the event, and special instructions 446 can provide any additional, unique, special, or other instructions that may be useful in dealing with the occurrence of the event.

Also illustrated in FIG. 8 is a machine readable identifier 150 that can be included on the label. For example a bar code or other machine-readable tag can be included to allow quick scanning by appropriate personnel. Preferably, the identifier is reproducible by copy, facsimile and other like transmission means. In other embodiments, the identifier can be an RFID tag or other like tag in machine readable form.

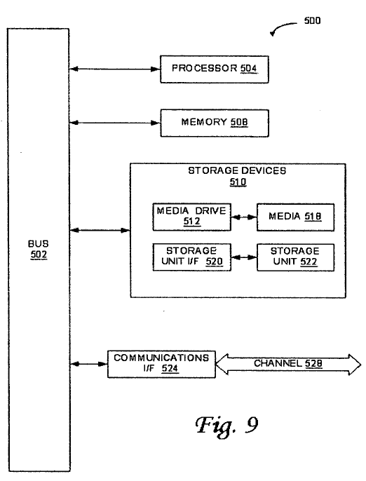

As the example depicted in FIG. 9 illustrates, numerous pieces of information can be provided in a material handling label in various formats. This example also illustrates one form (a label) of an output of the system in response to an event.

Various forms of control logic can be used to implement the various features and functions associated with the invention. Such control logic can be implemented using hardware, software, or a combination thereof. For example, one or more servers, computing systems, controllers, processors, processing systems, ASICs, PLAs, and other computing devices, logic devices, modalities or components can be included to implement the desired features and functionality.

In fact, in one embodiment, these elements are implemented using one or more computing systems capable of carrying out the functionality described with respect thereto. One such example computing system is shown in FIG. 8. Computing system 500 may represent, for example, desktop, laptop and notebook computers; hand held computing devices (PDA's, smart phones, palmtops, etc.); mainframes, supercomputers, or servers; or any other type of special or general purpose computing devices as may be desirable or appropriate for a given application or environment.

Referring now to FIG. 9, the computing system 500 can include one or more processors, such as a processor 504. Processor 504 can be implemented using a general or special purpose processing engine such as, for example, a microprocessor, controller or other control logic.

In the example, processor 504 is connected to a bus 502 or other communication medium. Various software embodiments are described in terms of this example computing system 500. After reading this description, it will become apparent to a person skilled in the relevant art how to implement the invention using other computer systems or architectures.

Computing system 500 also includes a main memory 508, preferably random access memory (RAM) or other dynamic memory, for storing information and instructions to be executed by processor 504. Main memory 508 also may be used for storing temporary variables or other intermediate information during execution of instructions to be executed by processor 504. Computing system 500 can likewise includes a read only memory (“ROM”) or other static storage device coupled to bus 502 for storing static information and instructions for processor 504.

The computing system 500 can also include information storage mechanism 510, which can include, for example, a media drive 512 and a removable storage interface 514. The media drive 512 can include a drive or other mechanism to support fixed or removable storage media. For example, a hard disk drive a floppy disk drive, a magnetic tape drive, an optical disk drive, a CD or DVD drive (read or read/write versions), or other removable or fixed media drive. Storage media 518, can include, for example, a hard disk, a floppy disk, magnetic tape, optical disk, a CD or DVD, or other fixed or removable medium that is read by and written to by media drive 514. As these examples illustrate, the storage media 518 can include a computer usable storage medium having stored therein particular computer software or data.

In alternative embodiments, information storage mechanism 510 may include other similar instrumentalities for allowing computer programs or other instructions or data to be loaded into computing system 500. Such instrumentalities can include, for example, a removable storage unit 522 and an interface 520. Examples of such can include a program cartridge and cartridge interface, a removable memory (for example, a flash memory) and memory slot, and other removable storage units 522 and interfaces 520 that allow software and data to be transferred from the removable storage unit 518 to computing system 500.

Computing system 500 can also include a communications interface 524. Communications interface 524 can be used to allow software and data to be transferred between computing system 500 and external devices. Examples of communications interface 524 can include a modem, a network interface (such as an Ethernet or other NIC card), a communications port (such as for example, a USB port), a PCMCIA slot and card, etc. Software and data transferred via communications interface 524 are in the form of signals which can be electronic, electromagnetic, optical or other signals capable of being received by communications interface 524. These signals are provided to communications interface 524 via a channel 528. This channel 528 can carry signals and can be implemented using a wireless medium, wire or cable, fiber optics, or other communications medium. Some examples of a channel can include a phone line, a cellular phone link, an RF link, a network interface, a local or wide area network, and other communications channels.

In this document, the terms “computer program medium” and “computer usable medium” are used to generally refer to media such as, for example, memory 508, storage device 518, a hard disk installed in hard disk drive 512, and signals on channel 528. These and other various forms of computer usable media may be involved in carrying one or more sequences of one or more instructions to processor 504 for execution. Such instructions (which may be grouped in the form of computer programs or other), when executed, enable the computing system 500 to perform features of the present invention as discussed herein. In particular, the computer programs, when executed, enable the processor 504 to perform the features of the present invention.

In an embodiment where the elements are implemented using software, the software may be stored in a computer program product and loaded into computing system 500 using removable storage drive 514, hard drive 512 or communications interface 524. The control logic (in this example, software instructions), when executed by the processor 504, causes the processor 504 to perform the functions of the invention as described herein.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but can be implemented using a variety of alternative architectures and configurations. Additionally, although the invention is described above in terms of various exemplary embodiments and implementations, it should be understood that the various features and functionality described in one or more of the individual embodiments are not limited in their applicability to the particular embodiment with which they are described, but instead can be applied, alone or in some combination, to one or more of the other embodiments of the invention, whether or not such embodiments are described and whether or not such features are presented as being a part of a described embodiment. Thus the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed across multiple locations.

What is claimed is:

1. A materials event response system, comprising:
an event module configured to receive event information from a caller, the event information comprising information pertaining to a materials event;
a data storage module configured to store data pertaining to a plurality of materials; and
a response generation module, communicatively coupled to the communication module and the data storage module, and configured to retrieve data from the data storage module based on the event information and further configured to generate a materials event response based on the retrieved information;
wherein the event module comprises an automated telephonic interface configured to prompt for the caller for event information.

2. The materials event response system of claim 1, wherein the event module further comprises a module configured to screen an incoming call.

3. The materials event response system of claim 1, wherein the event module further comprises a module configured to determine an identification of the event originator.

4. The materials event response system of claim 3, wherein identification of the event originator comprises an identification of a service site, department, or requesting personnel.

5. The materials event response system of claim 3; wherein identification of the event originator is determined based on ANI or DNIS information or based on caller input.

6. The materials event response system of claim 3, further comprising a module configured to verify the validity of the event originator.

7. The materials event response system of claim 1, wherein the event module further comprises a module configured to receive information regarding the type of materials involved in the event being reported.

8. A method of responding to a materials event, the method comprising the steps of:
receiving a telephone call from a caller reporting an event involving materials from a service site, the call being received by an automated telephonic interface module;
the automated telephonic interface module gathering information about the event from the caller and providing the gathered information to a response module;
the response module retrieving information relating to the material and generating a response to the material event, the response incorporating the retrieved information; and
providing the response to the event.

9. The method of claim 8, wherein the step of gathering comprises the steps of prompting the caller for the information, and accepting the caller's responses by voice recognition or keypad entry.

10. The method of claim 8, wherein the step of gathering comprises the step of determining the information based on ANI or DNIS information associated with the telephone call.

11. The method of claim 8, further comprising the step of screening the incoming call.

12. The method of claim 11, further comprising the step of rerouting the call based on information received during screening.

13. The method of claim 8, further comprising the step of determining an identification of the event originator.

14. The method of claim 13, wherein identification of the event originator comprises an identification of a service site, department, or requesting personnel.

15. The method of claim 8, further comprising the step of determining an identification of the material involved in the event based on input provided by the caller.

16. The method of claim 8, further comprising the step of playing a script to the caller providing instructions regarding how to obtain the response.

17. A computer program product comprising a computer readable medium having computer program code stored thereon for responding to a materials event, comprising:
first computer program code configured to accept a telephone call from a caller reporting an event involving materials from a service site;
second computer program code configured to gather via an automated telephonic interface information about the event from the caller;
third computer program code configured to retrieve information relating to the material and to generate a response to the material event, the response incorporating the retrieved information.

18. The computer program product of claim 17, wherein the first computer program code is configured to prompt the caller for the information, and accept the caller's responses by voice recognition or keypad entry.

19. The computer program product of claim 17, further comprising computer program code configured to determine an identification of the caller based on ANI or DNIS information associated with the telephone call.

20. The computer program product of claim 19, wherein identification of the caller comprises an identification of a service site, department, or requesting personnel.

21. The method of claim 17, further comprising computer program code configured to screen the incoming call.

22. The method of claim 17, further comprising computer program code configured to reroute the call based on information received during screening.

23. The method of claim 17, further comprising computer program code configured to determine an identification of the event originator.

24. The method of claim 17, further comprising computer program code configured to determine an identification of the material involved in the event based on input provided by the caller.

25. The method of claim 17, further comprising computer program code configured to play a script to the caller providing instructions regarding how to obtain the response.
